(19) United States
(12) Patent Application Publication
(10) Pub. No.: US 2009/0077129 A1
(43) Pub. Date: Mar. 19, 2009

(54) SPECIFYING METADATA ACCESS FOR DIGITAL CONTENT RECORDS

(76) Inventor: Andrew C. Blose, Penfield, NY (US)

Correspondence Address: David A.Novais;Patent Legal Staff, Eastman Kodak Company, 343 State Street, Rochester, NY, 14650-2201, US

(21) Appl. No.: 11/854,751

(22) Filed: Sep. 13, 2007

(51) Int. Cl. G06F 17/30

(52) U.S. Cl. 707/104.1; 707/E17.01

(57) ABSTRACT

Metadata associated with a digital content record is modified, where the digital content record is to be provided to a particular recipient, and has associated therewith an account. A recipient list associated with the account identifies one of three or more metadata detail levels associated with each of a plurality of potential recipients. In this regard, a particular metadata detail level is determined based at least upon a comparison of the particular recipient and the recipient list. Then, the metadata associated with the digital content record is adjusted in accordance with the particular metadata detail level. Accordingly, a relative detail, or resolution, of information provided by the metadata may be controlled.

### FIELD OF THE INVENTION

This invention generally relates to digital image processing and more particularly relates to selective access to metadata that is associated with digital content records such as digital still images, digital videos, and digital audio files.

### BACKGROUND OF THE INVENTION

The widespread acceptance and use of the internet and related network tools have provided opportunities for a growing number of applications that enable sharing of various types of digital data content. One type of application that has been particularly popular is the on-line storage and sharing of digital images and digital video and audio content, obtained largely from digital cameras and related devices. As the growth of digital imaging continues to escalate, there is increasingly more consumer interest in making at least some captured images and image-related content available for distribution to various types of recipient sites over the internet or other network.

Metadata, as the term is used in the data processing arts, is “data about data”. For a data record, such as a digital data image, digital audio record, digital video or animation record, or other similar type of data structure, metadata is data that encodes one or more fields of descriptive information about the context, condition, quality, and other characteristics of the data. One familiar model for metadata is provided by a library catalog, for example. For each book on the library shelves, detailed information is maintained about the book, including author, publisher, date of publication, number of pages, location, and similar information. This stored information is considered metadata. More generally, for a digital content record, metadata can include document data about data elements or attributes, (name, size, data type, etc), data about records or data structures (length, fields, columns, etc), data about data (where it is located, how it is associated, ownership, etc.). Metadata may include descriptive information about the context, quality and condition, or characteristics of the data.

One aspect of digital image storage that makes it possible to selectively share digital images is the association of metadata with stored image content. For example, images currently obtained from a digital camera often have accompanying metadata that describes date, time, and location of image capture, conditions under which the image was obtained, and photographer identification, and can even have various data about the image content itself. Standard information data fields or “tags” that can accompany an image are defined, for example, in the Digital Still Camera Image File Format Standard, also termed the EXchangeable Image File or EXIF Standard, v.2.1, from the Japan Electronic Industry Development Association (JEIDA) CP-3451. Using metadata allows an image collection or database to be quickly searched and permits its contents to be readily classified in various ways.

Metadata can be particularly useful for image processing, indexing, print rendering, and many other purposes, however, the owner of an image or other type of digital content record may not want the image metadata to be shared with all receivers because of privacy, security, and other considerations.

To date, there have been some attempts to address the problem of metadata security for images and other types of digital content records. For example, computer programs can extract and erase metadata from a digital file. One example of such software is “Out-Of-Sight” software provided by Soft Wise Corporation, Lexington, N.Y., U.S.A. This type of software permits a user to identify a document, such as a text document generated using popular word processing and presentation software, and selectively or automatically excise all metadata within the document so that the document can be transmitted without risk of unintentionally sharing metadata. Further, many image processing programs and algorithms will automatically destroy metadata when they modify images as a part of the image manipulation process. Other conventional solutions can be used to simply strip all metadata from an image before allowing image content to be viewed or transmitted. However, this rather drastic solution permanently removes the metadata, thereby preventing useful metadata from being provided along with digital image content. Commonly assigned U.S. Patent Application No. 2004/0123131 entitled “Image Data Processing System and Method” by Zacks et al. provides a method for specifying access to particular metadata fields by assigning a profile to each potential receiver of the metadata for an image. Any particular receiver may be denied access to information in one or more fields.

Still other conventional solutions include providing encryption for metadata. However, although this can provide some level of protection, decryption can require a separate processing step that is undesirable for users. Further, decryption keys can be lost or compromised. Various types of metadata strippers have also been used for removing encoded steganographic information.

The metadata that corresponds to an image or other digital content record can have value to those who share the digital content record with the owner. Stripping of whole metadata fields from the file may enhance security in some ways, but can prevent potentially useful metadata from being accessible for one or more images. It can be appreciated that there is a need in the art for solutions that restrict access to some fields of highly specific information without completely masking this information from a recipient.

### SUMMARY

The above-described problem is addressed and a technical solution is achieved in the art by systems and methods for modifying metadata associated with a digital content records, according to various embodiments of the present invention.

In an embodiment of the present invention, a digital content record to be provided to a particular recipient is identified. The digital content record is associated with an account and has metadata associated therewith. In addition, a recipient list associated with the account is identified. The recipient list identifies one of three or more metadata detail levels associated with each of a plurality of potential recipients. In this regard, a particular metadata detail level is determined based at least upon a comparison of the particular recipient and the recipient list. The metadata associated with the digital content record may be adjusted in accordance with the particular metadata detail level. Accordingly, embodiments of the present invention, such as this one, allow the amount of detail of the metadata to be adjusted on a recipient-by-recipient basis.

For example, in one embodiment, the adjusting step adjusts a resolution of information represented by the metadata, the resolution being determined by the particular metadata detail level. The information may include a specific location of capture of the digital content record, and the adjusting step may include moving the specific location to a regional location.

In order to allow even greater control as to the amount of metadata detail provided to recipients, some embodiments of the present invention determine the particular detail level based at least upon (a) the comparison of the particular recipient and the recipient list and (b) an analysis of content associated with the digital content record. For example, the digital content record may be an image record, and the analysis of content may include determining whether particular faces, such as particular children's faces are represented by the image record. For another example, the analysis of content may include determining whether the digital content record was captured at a home location associated with the account. For yet another example, the analysis of content comprises determining privacy attributes associated with where the digital content record is stored.

In addition to the embodiments described above, further embodiments will become apparent by reference to the drawings and by study of the following detailed description.

### BRIEF DESCRIPTION OF THE DRAWINGS

The present invention will be more readily understood from the detailed description of exemplary embodiments presented below considered in conjunction with the attached drawings, of which:

FIG. 1 is a schematic diagram showing an image collection that is accessible to multiple recipients on a network;

FIG. 2 is a table showing an exemplary listing of metadata available at various detail levels according to one embodiment;

FIG. 3 is a table showing a recipient list in one embodiment;

FIG. 4 is an example of a user interface window for making a privacy setting for metadata corresponding to a digital content record; and

FIG. 5 is a logic flow diagram for the process of providing a digital content record and its associated metadata.

It is to be understood that the attached drawings are for purposes of illustrating the concepts of the invention and may not be to scale.

### DETAILED DESCRIPTION

While metadata can be particularly useful for image processing, indexing, print rendering, and many other purposes, the owner of an image or other type of digital content record may not want the image metadata to be shared with all receivers because of privacy, security, and other considerations. For example, there may be third parties to whom it might not be prudent to allow full access to metadata that is associated with a particular image. For instance, various fields of information in the EXIF format can store precise Global Positioning System (GPS) coordinates corresponding to the image that has been captured, as well as date and time data. As a privacy concern, it may not be desirable to allow access to exact Global Positioning System (GPS) coordinates data and to date/time information with all images in a digital image collection. In addition, identifying information that is specific to individuals in a set of images may be data that an image owner prefers to keep private.

Unlike conventional schemes, embodiments of the present invention adjusts the relative detail, or resolution, of information provided by metadata. For example, where original metadata may specify an exact location of capture for a digital content record, embodiments of the present invention may replace the exact location with a regional location, such as the nearest town center.

Various embodiments of the present invention pertain to the organization and distribution of digital content records, such as digital still images, digital videos, digital audio files, document files, and other types of digital data records that may be collected and stored by a user. The description that follows uses the digital image as one example of a digital content record, for the purpose of describing various embodiments of the present invention.

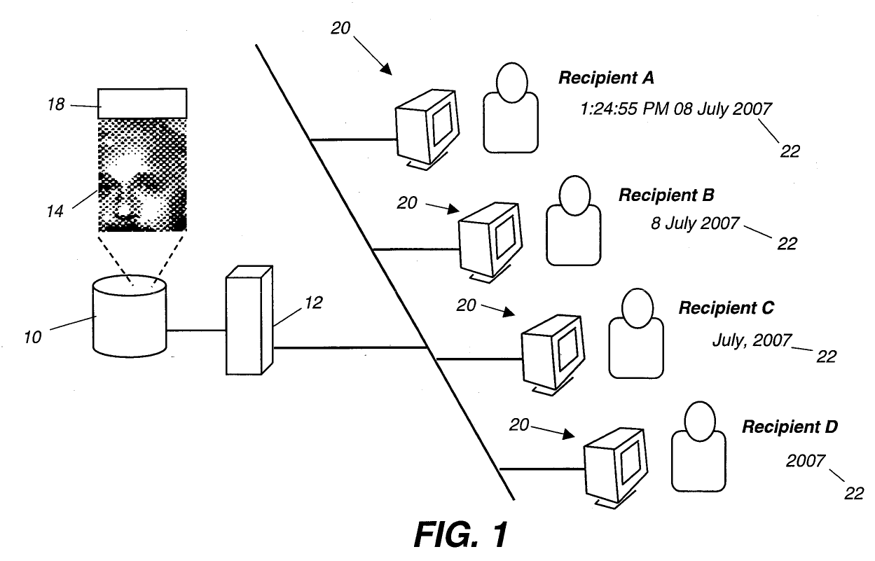

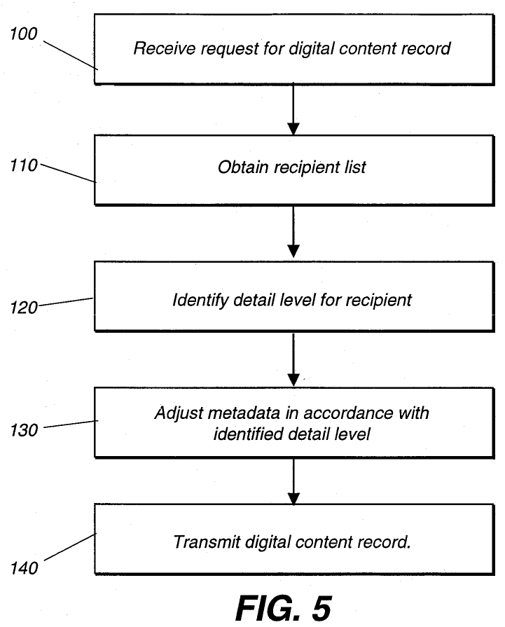

Embodiments of the present description are directed to elements forming part of, or cooperating more directly with, apparatuses. It is to be understood that elements not specifically shown or described may take various forms well known to those skilled in the art. In this regard, FIG. 1 illustrates a networked arrangement in which an image collection is stored in a computer-accessible memory system 10, which is communicatively connected to a computer system 12. The computer system 12 includes one or more computers that implement the processes of the various embodiments of the present invention, including the example processes described herein and the process of FIG. 5. Also communicatively connected to the computer system 12 are recipient computer systems 20, from which recipients A-D may receive images from the image collection stored in the computer-accessible memory system 10. The recipient computer systems 20 also include one or more computers.

The term “computer” is intended to be a synonym for or include any data processing device, such as a central processing unit (“CPU”), a desktop computer, a laptop computer, a mainframe computer, a personal digital assistant, a Blackberry™, a digital camera, or any other device for processing data, managing data, or handling data, whether implemented with electrical, magnetic, optical, biological components, or otherwise. In this regard, the phrase “computer system” may be used herein as a synonym for “data processing system.”

The computer-accessible memory system 10 includes one or more computer-accessible memories configured to store the image collection or other information needed to execute the processes of the various embodiments of the present invention described herein, including the example process of FIG. 5. The computer-accessible memory system 10 may be a distributed data storage system including multiple computer-accessible memories communicatively connected to the computer system 12 via a plurality of computers or devices. On the other hand, the computer-accessible memory system 10 need not be a distributed data storage system and, consequently, may include one or more computer-accessible memories located within a single computer or device.

The phrase “computer-accessible memory” is intended to include any computer-accessible data storage device, whether volatile or nonvolatile, electronic, magnetic, optical, or otherwise, including but not limited to, floppy disks, hard disks, Compact Discs, DVDs, flash memories, ROMs, or RAMs.

The phrase “communicatively connected” is intended to include any type of connection, whether wired or wireless, between devices, computers, or programs in which data may be communicated. Further, the phrase “communicatively connected” is intended to include a connection between devices or programs within a single computer, a connection between devices or programs located in different computers, and a connection between devices not located in computers at all. In this regard, although the computer-accessible memory system 10 is shown separately from the computer system 12, one skilled in the art will appreciate that the computer-accessible memory system 10 may be stored completely or partially within the computer system 12.

The image collection stored in the computer-accessible memory system 10 can include multiple images 14 stored by a consumer who has membership, or an account, in a system such as the KODAK EasyShare™ Gallery, for example. In this regard, it can be said that images 14 in the image collection are associated with an account.

Image 14 is one type of “digital content record”, as this term is used in the present disclosure. Each image 14 can have associated metadata 18 about the image. Some of the metadata 18 has no personal content, but simply describes attributes of its corresponding image 14 or other digital content record. For example, some metadata can be thumbnail image data, information on resolution of the original image or on image data arrangement, number of samples per pixel, and similar information that can be considered as neutral with respect to personal content. This type of metadata 18 describes a high percentage of the fields of data for images stored in EXIF format, as was noted earlier in the background section. Other types of metadata 18 can have content of a more personal or private nature. Such metadata may include user-entered information about the image subject, such as names of people in the image, places, comments, and other personal data that is related in some way to the image subjects or other content or to the image context. Metadata 18 can be stored in a separate file or files that are associated or linked in some way with the image's content. Alternately, metadata 18 can be obtained from the account owner and used for organizing or categorizing images, stored in a database of some type. Metadata 18 could also be encoded directly into the image content, audio content, or other data in the digital content record. For example, steganography techniques, well known to those skilled in the image encoding arts, can be used to encode information within the image data itself, using otherwise unused or hidden bits in the image data structure.

At least portions of image collection 10 are intended to be shared via recipient computer systems 20 with one or more networked recipients, labeled Recipients A-D in FIG. 1. A user who has an account administered at server 12 can have some images or other data content records that are private, accessible only to the owner account, and other images that are public. Alternately, any image 14 might be publicly accessible to recipients A-D. It should be noted that the term “recipient”, as used herein may be an individual, a group of individuals, or a group of sub-groups of individuals, or a group of both individuals and sub-groups of individuals.

Metadata 18 that is associated with image 14 can include some information to which a user may not want to allow global access. For example, a user may be sensitive about providing GPS data for backyard images, name of subjects in the image for family photos, date and time data, and other detailed information related to image 14. In light of this sensitivity, an embodiment of the present invention allows the account owner of image 14 or other data content record to set up various levels of access to metadata 18 to different groups of recipients 20. FIG. 1 shows an item 22 of metadata that is provided at different detail levels. Recipient A, for example, has access to the full date and time stamp given in this example. Recipient B has access to month and day data. Recipient C is given access only to month and year. Recipient D, given the lowest level of detail access, can obtain year information for the requested image 14. In the same spirit, additional detail levels could be designated for one or more recipients, including a detail level that allows no access at all to one or more metadata items associated with a digital content record.

There are some types of metadata where different detail levels are possible. One of these is the date/time stamp information shown in the example of FIG. 1. An image detail level with the highest specificity or resolution can provide the exact time stamp that is assigned to the digital image by the digital camera itself, shown provided to recipient A in FIG. 1. At the opposite end of the scale, merely providing the year or providing no date/time metadata at all might be appropriate for some recipients.

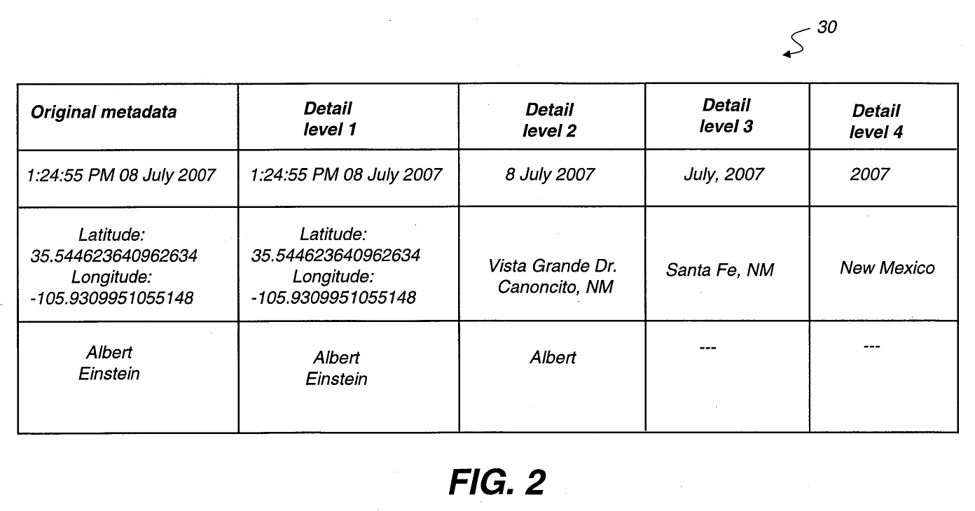

Referring to FIG. 2, there is shown an exemplary detail level listing 30 that can be set up by an owner of an account that includes an image collection or other collection of digital content records. The original metadata includes fields with information such as complete date/time stamp, GPS coordinates, and name(s) of individual subject(s) in the image. In this example, four detail levels are set up. Detail level 1 allows access to all of the metadata, without adjustment of the data content. The highest access of detail level 1 may be most suitable, for example, to family members or close friends, for whom full access to all of the metadata would not be unreasonable. Detail level 2 adjusts the specificity or resolution of the metadata for the fields shown. Detail level 2 might be appropriate, for example, for a circle of acquaintances who would be considered “friendly” visitors to an image storage account. The date/time stamp is less precise, giving only the date, month, and year. The GPS information can be adjusted in a number of ways, such as by truncating latitude and longitude values, by substituting reference values for a nearby coordinate, or by substitution of related location data, as shown in the example of FIG. 2. This shows another aspect of the present invention: namely, that the type of data provided to the recipient can be changed as part of the process of reducing specificity. Other examples of the change of type of data can be, for example, to substitute holiday names for the date/time stamp information given in the first row.

Continuing with the example of FIG. 2, detail level 3 is provided to make less specific metadata available. This may be the appropriate detail level for an image that is of interest to a group, organization, or other set of individuals likely to have a special interest in images of a certain type or of certain subjects. In the example shown, some of the personal metadata is stripped, unavailable to recipients assigned this detail level. Location information is provided in a more general form than was shown for detail level 2, simply listing a nearby city and state.

Detail level 4, the lowest access level in FIG. 2, is provided for general access to recipients who might be unknown to the image owner. This may be the “global” access level, assigned by default to any recipient until the recipient is further identified and can be assigned a higher access level.

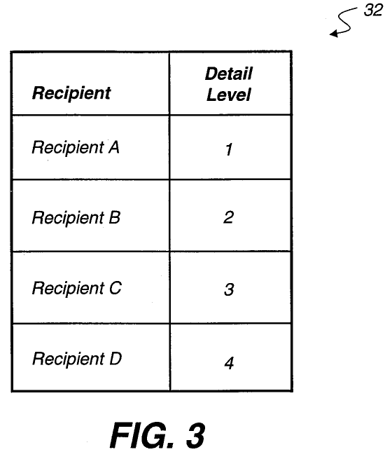

Once the three or more detail levels of detail listing 30 are determined, either using a system default or by explicit setup performed by the customer, access levels for individual recipients or groups of recipients can be assigned. FIG. 3 shows a recipient list 32 that can be used to assign a detail level to each recipient. In practice, explicit assignment of detail levels for each and every possible recipient could be prohibitively time-consuming. Instead, detail level assignment can use any of a number of existing lists or configuration groupings that are already in place for a networked customer. For example, use of net and subnet assignments for a set of IP addresses allow assignment of detail level access to a broad group of potential recipients. Continuing with the examples shown in FIGS. 2 and 3, every address in the local subnet, network group, or sub-group, may be automatically assigned to detail level 2. Alternately, a user's email list, or other user-defined grouping, could be used to generate portions of recipient list 32. It should be emphasized that recipient list 32 need not be a listing that explicitly correlates each recipient or group of recipients to a detail level as shown in the example of FIG. 3. Recipient list 32 could alternately be implemented by following a sequence of rules that determine the detail level access that is allowed for any recipient at the time an image and its metadata are requested. This type of sequence, using rules, effectively generates recipient list 32 in a more dynamic manner, as needed, rather than forming an indexed data structure, as might otherwise be suggested from the example of FIG. 3.

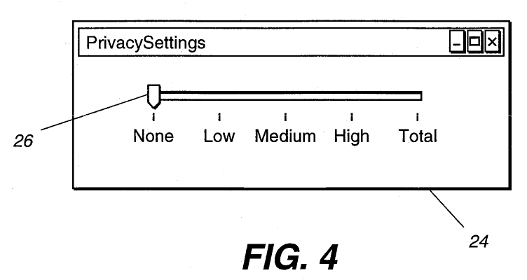

Any of a number of operator interface utilities can be used to set up detail levels for an individual image collection. In one embodiment, a user sets up recipient list 32 directly, explicitly assigning detail level access to one or more individuals or groups, following the basic model of FIG. 3, for example. As shown in the example of FIG. 4, user interface tools, such as a window 24, can be displayed on the operator's workstation. A control 26 allows setting of detail level to each listed recipient. In another embodiment, privacy settings using window 24 or other tool can be designated for individual images in the collection. Then, only individuals or groups having the appropriate detail level would be able to access various images and their associated metadata.

The logic flow diagram of FIG. 5 shows a sequence of steps for providing metadata that is associated with an image or other type of digital content record. In a request step 100, a request for a specific digital content record is received from a recipient account. An obtain-recipient-list step 110 is executed, identifying a recipient list detail level entry for the recipient account. As noted earlier, the detail level for a particular recipient can be explicitly entered for an account or for some grouping of accounts or may be obtained by applying a sequence of rules for determining detail level assignment. For either arrangement, a level-identification step 120 identifies the detail level assignment that is associated with the recipient. A metadata-adjustment step 130 then adjusts the metadata detail level appropriately. A transmission step 140 then provides the requested digital content record, with its adjusted metadata, to the recipient.

The adjusted metadata can be provided in a number of ways. In some embodiments, such as those in which the EXIF standard is used, adjusted metadata is provided in the image header data that is included with the image data. The adjusted metadata can also be displayed or provided in a separate file that is associated with the image.

Adjustment of the metadata that is provided with the digital content record can take any of a number of forms. In one embodiment, metadata may be converted to more general data. For example, referring to FIG. 2, it can be seen that GPS data can be converted to standard geographical locations in order to provide less specificity. Similarly, date/time stamp data can be changed to seasonal references or to other time periods, such as “Freshman Year”, for example. In one embodiment, the owner of an image collection or other set of digital content records can enter the type of information that is made available for each detail level. In another embodiment, another database is used for correlating the actual metadata that is stored with the digital content record with the metadata that is available to a recipient at a specific detail level. This auxiliary database could be, for example, a database of landmarks, such as that described in U.S. Pat. No. 6,766,245 entitled “Landmark-Based Location of Users” to Padmanabhan.

It should be noted that although the examples shown in FIG. 2 sometimes depict data type changes when generalizing data, e.g., specific numerical GPS coordinates are generalized to textual location names, one of ordinary skill in the art will appreciate that data can be generalized without data type changes. For example, specific numerical GPS coordinates may be changed to the numerical GPS coordinates of the nearest street (Vista Grande Dr.), the nearest town (Santa Fe), or the nearest state (New Mexico), etc.

There are a number of options for setting up recipient account access to various detail levels and for determining what type of information is provided at each detail level. In some embodiments, the account owner can configure detail level access and handling, such as for geographical, time-stamp, subject identification, and other metadata. In other embodiments, software associated with the digital content record storage and management system provides a predetermined set of detail levels for assignment to recipients by the account owner.

In some embodiments, the owner of the digital content record may exercise additional control over what resolution of metadata information is transmitted to recipients having particular detail levels. In particular, in addition to determining a recipient's detail level in order to determine the resolution of metadata information transmitted to the recipient, other metadata or non-metadata content associated with the digital content records at issue may be utilized. For example, an image that contains faces, particular faces, or voice audio content for one or more voices, as determined by an analysis of metadata or non-metadata content associated with the image, could have less information transmitted to recipients of a particular detail level than an image that does not contain such faces, etc. A more specific example is that if an image contains a particular child's face, no “name” information for that child may be transmitted to a recipient associated with a detail level of “2”. However, all other children's faces could have a first name for each child transmitted to the same recipient associated with the detail level of “2”.

Another example pertains to an image's location of image capture, where images taken at an account owner's home, as determined by an analysis of metadata content, might have less information transmitted to a group of recipients of the same detail level than images not taken at the account owner's home.

Further in this regard, the resolution of information transmitted to recipients of a same detail level may vary from image to image depending upon where the image is stored. For example, metadata information resolution may vary depending upon whether an image is stored in a “private album” verses a “public album”, or if an image is stored in a “shared” folder versus a non-shared folder.

Although one aspect of various embodiments of the method of the present invention relates to automated handling of recipient requests for a user account, there can also be some level of interaction when a request is received. A customer may, for example, want to screen recipient requests and determine how to handle requests from recipients who have not been specifically identified. As each recipient request is handled, the given detail level assignment for the recipient can then be stored in recipient list 32 (FIG. 3), allowing recipient list 32 to be configured and edited over time. Responses can also be learned, so that, for example, inferences can be made based on recipient list detail level assignments over time.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, although the preceding description concentrates on providing images and their associated metadata as digital content records (FIG. 1), other types of digital content could similarly be provided, such as audio content or video content. To make metadata content less specific for suitability to an individual detail level, conversion of data from one type to another can also be implemented, as was described earlier with reference to GPS data.

### PARTS LIST

10. Computer-Accessible Memory System
12. Computer System
14. Image
18. Metadata
20. Recipient Computer System
24. Window
26. Control
30. Detail level listing
32. Recipient list
100. Request step
110. Obtain recipient list step
120. Level identification step
130. Metadata adjustment step
140. Transmission step

What is claimed is:

1. A method for modifying metadata associated with a digital content record, the method implemented at least in part by a computer system and comprising the steps of:
identifying a digital content record to be provided to a particular recipient, the digital content record associated with an account and having metadata associated therewith;
identifying a recipient list associated with the account, the recipient list identifying one of three or more metadata detail levels associated with each of a plurality of potential recipients;
determining a particular metadata detail level based at least upon a comparison of the particular recipient and the recipient list; and
adjusting the metadata associated with the digital content record in accordance with the particular metadata detail level.

2. The method of claim 1, wherein the particular recipient is a group.

3. The method of claim 2, wherein the group includes sub-groups.

4. The method of claim 2, wherein the group includes individuals.

5. The method of claim 1, wherein the particular recipient is an individual.

6. The method of claim 1, wherein the adjusting step adjusts a resolution of information represented by the metadata, the resolution being determined by the particular metadata detail level.

7. The method of claim 6, wherein the information includes a specific location of capture of the digital content record, and the adjusting step comprises moving the specific location to a regional location.

8. The method of claim 1, wherein the adjusting step comprises converting one or more metadata fields from mathematical data to text data.

9. The method of claim 1, wherein the determining step determines the particular detail level based at least upon (a) the comparison of the particular recipient and the recipient list and (b) an analysis of content associated with the digital content record.

10. The method of claim 9, wherein the digital content record is an image record, and wherein the analysis of content comprises determining whether particular faces are represented by the image record.

11. The method of claim 10, wherein the particular faces are faces of particular children.

12. The method of claim 9, wherein the content is non-metadata content associated with the digital content record.

13. The method of claim 9, wherein the content is metadata content associated with the digital content record.

14. The method of claim 13, wherein the analysis of content comprises determining whether the digital content record was captured at a home location associated with the account.

15. The method of claim 13, wherein the analysis of content comprises determining privacy attributes associated with where the digital content record is stored.

16. A computer-accessible memory system storing instructions configured to cause a data processing system to implement a method for modifying metadata associated with a digital content record, wherein the instructions comprise:
instructions for identifying a digital content record to be provided to a particular recipient, the digital content record associated with an account and having metadata associated therewith;
instructions for identifying a recipient list associated with the account, the recipient list identifying one of three or more metadata detail levels associated with each of a plurality of potential recipients;
instructions for determining a particular metadata detail level based at least upon a comparison of the particular recipient and the recipient list; and
instructions for adjusting the metadata associated with the digital content record in accordance with the particular metadata detail level.

17. The computer-accessible memory system of claim 16, wherein the instructions for adjusting adjust a resolution of information represented by the metadata, the resolution being determined by the particular metadata detail level.

18. The computer-accessible memory system of claim 16, wherein the instructions for determining determine the particular detail level based at least upon (a) the comparison of the particular recipient and the recipient list and (b) an analysis of content associated with the digital content record.

19. A system comprising:
a data processing system; and
a memory system communicatively connected to the data processing system and storing instructions configured to cause the data processing system to implement a method for modifying metadata associated with a digital content record, wherein the instructions comprise:
instructions for identifying a digital content record to be provided to a particular recipient, the digital content record associated with an account and having metadata associated therewith;
instructions for identifying a recipient list associated with the account, the recipient list identifying one of three or more metadata detail levels associated with each of a plurality of potential recipients;
instructions for determining a particular metadata detail level based at least upon a comparison of the particular recipient and the recipient list; and
instructions for adjusting the metadata associated with the digital content record in accordance with the particular metadata detail level.

20. The system of claim 19, wherein the instructions for adjusting adjust a resolution of information represented by the metadata, the resolution being determined by the particular metadata detail level.

21. The system of claim 19, wherein the instructions for determining determine the particular detail level based at least upon (a) the comparison of the particular recipient and the recipient list and (b) an analysis of content associated with the digital content record.
